(19) United States
(12) Patent Application Publication
(10) Pub. No.: US 2003/0009543 A1
(43) Pub. Date: Jan. 9, 2003

(54) Network management system and computer-based methods for network management

(76) Inventor: Ankur Gupta, Bangalore (IN)

Correspondence Address: HEWLETT-PACKARD COMPANY, Intellectual Property Administration, P.O. Box 272400, Fort Collins, CO, 80527-2400, US

(21) Appl. No.: 09/845,456

(22) Filed: Apr. 30, 2001

(51) Int. Cl. G06F 15/173; G09G 5/00

(52) U.S. Cl. 709/223; 345/736

(57) ABSTRACT

A network management system comprising a network management master-agent process having a first interface being adapted to communicate with a network management software module using a network management protocol format and having a second interface being adapted to communicate with a plurality of network management sub-agent processes using an object-oriented interface description language format. The network management master-agent process further comprises a converting unit for converting a message according to the network management protocol format into the object-oriented interface description language format and vice versa.

### BACKGROUND OF THE INVENTION

1. Field of the Invention

The present invention relates to a network management system and computer-based methods for network management.

2. Description of the Related Art

Connecting computers to a network has become usual in the last decade, as this involves a lot of advantages. Facilities like software or printers can be shared by a group of people working on networked computers. Teamwork within a group of people is promoted, as the common access to data bases is enabled and as functions like email or electronic diary are provided. Examples for computer networks are local area networks (LANs) in a company or in an office or the internet.

The handling of large computer networks is complex and difficult to survey. Automatization and simplification of administrative jobs is achieved by implementing software tools organizing a computer network. The stable functioning of a computer network requires monitoring of the system. Therefore, monitoring of parameters characterizing the operations and processes on a computer system is an important matter in network management.

In the related art this kind of monitoring is often realized by a network management software basing on SNMP. SNMP (Simple Network Management Protocol) is a standard protocol governing network management and monitoring of network devices and applications. FIG. 1A shows a model of an SNMP-based architecture of network management. Referring to FIG. 1A, an SNMP-based network management architecture 100 introduces the following main components: a plurality of network elements 101 like hosts, gateways, printers, etc. which are monitored and controlled by agent processes, wherein an agent process is an autonomic working computer program. Further, the network management architecture 100 comprises a network management station 102 which is collecting and monitoring information about the net elements 101 and controlling their actions. The network management protocol 103, e.g. the Simple Network Management Protocol (SNMP), determines the rules of the communication and the data exchange between the network management station 102 and the net elements 101. The Management information pertaining to the application (the specific parameters of the application that the user wants to monitor and manage) is specified in the Management Information Base (MIB), which is expressed in Abstract Syntax Notation (ASN.1) format—a standard format for specifying MIBs.

SNMP is not the only existing network management protocol, for instance CMIP (Common Management Information Protocol) is an alternative solution to SNMP.

The scheme of an architecture for SNMP monitoring on a UNIX system in the related art is shown in FIG. 1B. The system of FIG. 1B particularly shows the architecture of a network management system 105 suitable for managing and monitoring a computer network with applications operated on a Hewlett Packard UNIX system (HP UX System) 106. A network management software module 107 which is usually a graphical user interface sends an SNMP request message 108 to a master-agent process 109. Hewlett Packard's Network Node Manager (NNM) is a well known example of a network management software module 107. The SNMP-based communication between the management application 107 and the master-agent process 109 is carried out by means of Protocol Data Units (PDU). Examples for PDUs are “Get-Requests” for querying an object from a management tree or “Set-Requests” for manipulating the values of the MIB variables (managed by an agent process) by the management application 107. In the scenario illustrated in FIG. 1B the SNMP request 108 can be a Get- or a Set-Command. The master-agent process 109 being aware of every single of a plurality of registered sub-agent processes 110 receives the SNMP request 108 and determines which of the sub-agent processes 110 is responsible for the present SNMP request 108 and should therefore receive the request. Each MIB variable representing a monitored entity is uniquely identified by an Object Identifier (OID). Each sub-agent process 110 in turn is responsible for managing a collection of MIB variables, which is referred to as the management tree for that particular sub-agent process 110. The master agent process 109 forwards the SNMP request 108 to that sub-agent process 110 for which the OID of the MIB variable in the SNMP request PDU, belongs to the management tree of the sub-agent process 110. In this context it should be recalled that in a MIB objects are arranged in a hierarchical order. The SNMP request 108 is transferred to the responsible one of the sub-agent processes 110. The sub-agent process 110 is responsible for providing the values of the MIB variables to be monitored, it is aware of these variables and it feeds the master-agent process 109 with the values for the monitored MIB variables by sending an SNMP response 112 back to the master-agent process 109 according to the respective SNMP request 108.

As one can gather from FIG. 1B, different kinds 110a, 110b, 110c of sub-agent processes 110 can be distinguished. For example, each Hewlett Packard UNIX system 106 provides a standard master-agent process 109 which supports some standard MIBs 111 like the Hewlett Packard-UNIX MIB 111a (for managing and monitoring system parameters like the CPU usage, the Memory usage, the File system monitoring, etc.) via the HP UX sub-agent process 110a or the so-called MIB II 111b via the MIB II sub-agent process 110b. Furthermore, application specific monitoring is supported by the so-called extensible sub-agent process 110c. The extensible sub-agent process 110c is responsible for application-specific, user-defined MIB 111c and passes a request 113 for monitored variables to a user process 114. The mechanism used for the communication of the SNMP extensible agent process 110c with a user process 114 is called IPC (Inter Process Communication). The user process 114 then provides the SNMP extensible sub-agent process 110c with the requested MIB variables by means of an IPC response 115.

In the frame of the described architecture in the related art the user is responsible for defining the MIB in the ASN.1 (Abstract Syntax Notation) format. A sub-agent process 110 then loads this file into its memory and begins processing SNMP requests 108 for the particular application 114.

The responsible sub-agent process 110 forwards the values of the MIB variables to be monitored to the master-agent process 109 by sending an SNMP response 112. This procedure is illustrated in FIG. 1B with arrows labelled “SNMP response” 112. The master-agent process 109 passes the MIB variables to the network management application 107 as a response 112 in the SNMP format. Therewith, the network management application 107 is provided with the information which is required for monitoring and managing the system.

However, a couple of problems occur due to the disadvantages and the limitations of the above mentioned master-agent—sub-agent SNMP monitoring architecture in the related art.

The SNMP monitoring architecture is suitable for applications operated on a single server. In this scenario it provides a single point of SNMP monitoring via the master-agent process. However, problems occur when centralized monitoring is required in the presence of distributed applications running on multiple machines.

A reason for this limitation is that each machine has its own master-agent process and sub-agent processes, so that there is no central point of monitoring when distributed applications are executed on various machines.

Another drawback in the state of the art is the fact that the SMNP extensible agent process requires the MIB in ASN.1 format. Therefore, the user has to be familiar with the complicated ASN.1 language. Beyond this, it is inconvenient and cumbersome to modify an existing ASN.1 file in a scenario, where the MIB keeps changing frequently. Therefore, it is inconvenient to extend or modify an existing MIB in order to adapt it to altered conditions when a user is working with a network management system according to the related art.

Further limitations result from available sub-agent process development toolkits generating code for a sub-agent process based on an input MIB. The latter needs to be put in and has to compiled afterwards. Available toolkits comprise some shortcomings:

Distributed applications running on various platforms are often not supported by toolkits. Furthermore, existing toolkits usually require the MIB in ASN.1 format resulting in the disadvantages mentioned above. Beyond this, if the MIB is modified, the code needs to be modified as well and the code for the sub-agent process needs to be recompiled again before usage.

### SUMMARY OF THE INVENTION

It is an object of the present invention to provide a network management system specifically suited for monitoring and managing distributed applications, resulting in greater flexibility and ease of use.

The object is achieved by providing a network management system and computer-based methods for network management with the features according to the independent claims.

A network management system is provided, comprising a network management master-agent process having a first interface being adapted to communicate with a network management software module using a network management protocol format, and further having a second interface being adapted to communicate with a plurality of network management sub-agent processes using an object-oriented interface description language format. The network management master-agent process further comprises a converting unit for converting a message according to the network management protocol format into the object-oriented interface description language format, and for converting a message according to the object-oriented interface description language format into the network management protocol format, respectively.

The present invention further provides a computer-based method for network management, comprising the steps of receiving a request message in a network management protocol format from a network management software module by a network management master-agent process, converting the request message from the network management protocol format into an object-oriented interface description language format and sending the converted request message in the object-oriented interface description language format to at least one network management sub-agent process.

The invention further provides another computer-based method for network management, comprising the steps of receiving a response message in an object-oriented interface description language format from a network management sub-agent process by a network management master-agent process, converting the response message from the object-oriented interface description language format into a network management protocol format and sending the converted response message in the network management protocol format to a network management software module.

The network management system and the computer-based methods for network management according to the invention substantially obviate various limitations and disadvantages imposed by the related art.

One of the advantages is that support for monitoring distributed applications is provided through the use of an object-oriented interface description language like CORBA. Due to the fact that the network management in the related art strictly bases a network management protocol like SNMP or CMIP, one can not benefit from the flexibility provided by object-oriented interface description languages like CORBA, as network management systems in the related art are restricted to the network management protocol format like SNMP. According to the present invention, CORBA-based sub-agent processes distributed across various machines provide management information to a single master-agent process. Implementing a CORBA-based master-agent—sub-agent architecture enables a user to monitor distributed applications via standard SNMP management software with a high degree of flexibility.

Therefore, monitoring distributed applications is simplified by the invention. While the conventional master-agent—sub-agent architecture solely allowed fragmented monitoring, the invention provides the opportunity of centralized monitoring by the means of a single master-agent process. The network management software module needs not to query master-agent processes on different computers for distributed components of an application. Complexity connected with distributed applications is moved into the system by using CORBA and is therefore shielded from the user. Thus the management of a network is simplified, and the user does not need to have special skills in CORBA, SNMP, ASN.1, etc.

It is another advantage of the invention that it provides the opportunity to specify an MIB in the intuitive and convenient XML format instead of the complicated ASN.1 format, as it is necessary according to the related art. The system is adapted to generate an ASN.1 file from an XML file, and advantageously such an XML file is very easy to write. Therefore, there is no necessity that the user has to be familiar with the ASN.1 language.

Beneficially, not only knowledge concerning ASN.1, also knowledge concerning SNMP and CORBA is dispensable for a user monitoring a network by the network management system and the computer-based methods for network management according to the present invention. This enables a large number of users to manage a network system and not only those skilled in this art.

Furthermore, the system is easily extensible for new MIBs. The user solely has to modify the XML file in a way that additional or modified MIBs are introduced therein. The system then converts the modified XML file into an ASN.1 format, but the user does not have to modify the complicated ASN.1 file.

Summarizing, the present invention provides an ease of use, a simple and convenient extensibility to additional or changed applications to be monitored and the opportunity of a centralized monitoring and managing of a distributed network system. Beyond this, the system is also operable by a user being not familiar with the SNMP, CORBA and ASN.1 languages.

The above and other objects, features and advantages of the present invention will become apparent from the following description and the appended claims, taken in conjunction with the accompanying drawings in which like parts or elements are denoted by like reference numbers.

### BRIEF DESCRIPTION OF THE DRAWINGS

The accompanying drawings, which are included to provide a further understanding of the invention and constitute a part of the specification illustrate embodiments of the invention.

In the drawings:

FIG. 1A is a schematic model of an SNMP-based network management architecture in the related art,

FIG. 1B is a schematic view of a network management system for SNMP monitoring on UNIX systems in the related art,

FIG. 2A is a network management system according to a preferred embodiment of the present invention,

FIG. 2B is a network management system according to another preferred embodiment of the present invention,

FIG. 2C is a network management system according to a further preferred embodiment of the present invention,

FIG. 3 is a network management system according to a further preferred embodiment of the present invention,

FIG. 4A is a flowchart of a computer-based method for network management according to a preferred embodiment of the present invention,

FIG. 4B is a flowchart of a computer-based method for network management according to another preferred embodiment of the present invention,

FIG. 5 is a flowchart of another computer-based method for network management according to a preferred embodiment of the present invention,

FIG. 6 is a data flowchart of a computer-based method for network management according to a preferred embodiment of the present invention,

FIG. 7 is a diagram showing the relationships of the classes for the master-agent—sub-agent architecture according to a preferred embodiment of the present invention,

FIG. 8 is a diagram showing the relationships of the classes for the sub-agent process architecture according to a preferred embodiment of the present invention.

### DETAILED DESCRIPTION OF PREFERRED EMBODIMENTS OF THE INVENTION

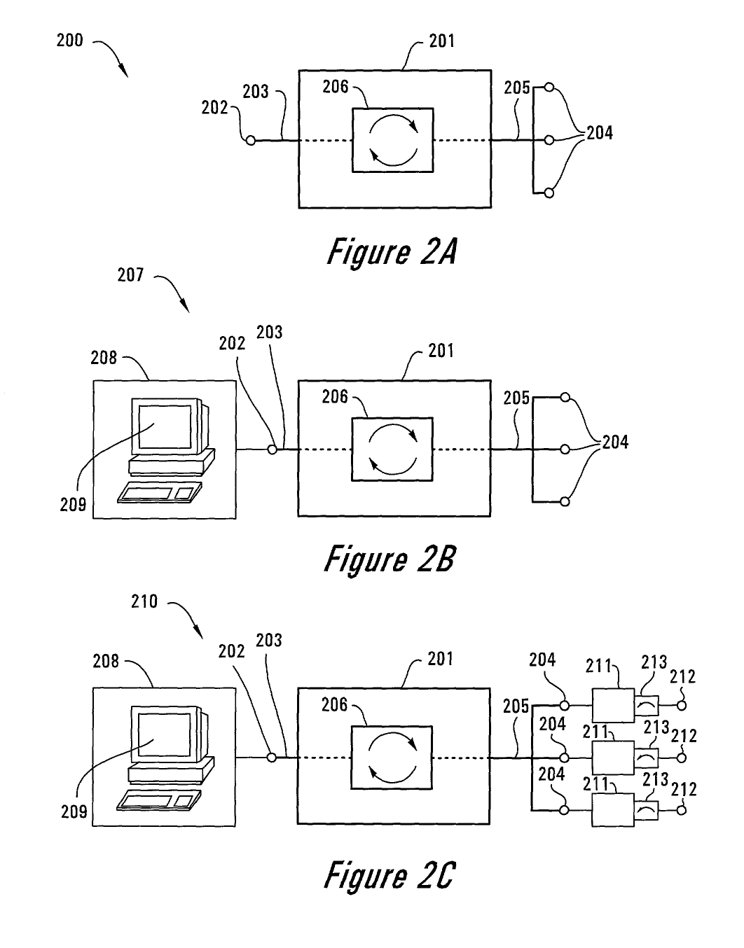

FIG. 2A shows a network management system 200 according to a preferred embodiment of the present invention comprising a network management master-agent process 201 having a first interface 202 being adapted to communicate with a network management software module using a network management protocol format 203, according to this embodiment SNMP. The network management master-agent process 201 further has a second interface 204 being adapted to communicate with three network management sub-agent processes using an object-oriented interface description language format 205, according to this embodiment CORBA. The network management master-agent process 201 further comprises a converting unit 206 for converting a message according to the network management protocol format 203 into the object-oriented interface description language format 205, and for converting a message according to the object-oriented interface description language format 205 into the network management protocol format 203, respectively.

In FIG. 2B a network management system 207 according to another preferred embodiment of the present invention is illustrated showing up additional features compared to the network management system 200 of FIG. 2A. The network management system 207 accessorily comprises a network management software module 208 coupled to the network management master-agent process 201 via the first interface 202. In addition, the network management software module 208 comprises a graphical user interface 209 for presenting network management information to a user.

Referring to FIG. 2C, another preferred embodiment of the network management system 210 according to the present invention is shown. In addition to the features described above referring to FIGS. 2A, 2B the network management system 210 illustrated in FIG. 2C further comprises three network management sub-agent processes 211 coupled to the network management master-agent process 201 via the second interface 204.

Beyond this, the network management system 210 comprises a MIB 212 for each network management sub-agent process 211, respectively, wherein each of the MIBs 212 is coupled to one network management sub-agent process 211.

It is understood that the network management system of FIG. 2A, FIG. 2B and FIG. 2C is just one possible embodiment of the invention. Therefore, the number of sub-agent processes 211 (three) is just exemplary. Obviously, the invention is not restricted to this example.

As shown in FIG. 2C, The network management sub-agent processes 211 comprise a further conversion unit 213 for converting data of a Management Information Base specified by a user in Extensible Markup Language (XML) format into the ASN.1 format. In other words: a user can input information to be specified in an MIB 212 in the simple XML format, and the further conversion unit 213 of a sub-agent process 211 converts this input file into an ASN.1 file.

The network management system 210 allows a user to monitor and supervise the network processes via the graphical user interface 209 which is part of the network management software module 208. The graphical user interface (GUI) 209 can for example be a monitor or any other display device. The operating system on which the user can control network system parameters (e.g. variables describing the CPU usage) can be a Windows NT operating system, but it can be any other suitable operating system as well. On such an operating system a network management application is operated which can be for example the Network Node Manager (NNM) version 5.0. The user can select a particular MIB variable to be monitored via the graphical user interface 209 and can issue a request for this variable. The format of such a request is the network management protocol 203. Particularly, this protocol 203 can be the Simple Network Management Protocol (SNMP) or the Simple Network Management Protocol Version 2 (SNMPv2). Assuming that the network management protocol 203 is SNMP, the request issued by the user can be an SNMP Get- or Set-request for the network variable of interest, for instance.

This request is sent from the user operating the network management software module 208, is transmitted via the first interface 202 to the network management master-agent process 201, and the SNMP request is received and parsed by the network management master-agent process 201. The converting unit 206 of the network management master-agent process 201 is capable of converting the SNMP request into the object-oriented interface description language format 205 using the respectively defined syntax. According to a preferred embodiment of the invention the object-oriented interface description language format 205 is the Common Object Request Broker Architecture (CORBA). In this case, the SNMP request is convertible into the CORBA format by the conversion unit 206.

At least one of the network management agent processes, i.e. the master-agent process 201 and/or at least one of the sub-agent processes 211, is operated on a UNIX operating system. In particular, the UNIX system is a Hewlett Packard UNIX system. However, the network management system of the invention is not restricted to the described scenario, and it is also possible that the agent processes are operated on any other suitable operating system. However, this would require specific porting to that platform and operating system.

As one can gather from FIG. 2C, the network management master-agent process 201 is coupled to at least one network management sub-agent process 211 via the interface 204. In the embodiment illustrated in FIG. 2C, the network management master-agent process 201 is coupled via the interface 204 to three network management sub-agent processes 211. Therefore, the network management master-agent process 201 is able to communicate with the network management sub-agent processes 211, for instance via CORBA-calls. However, in general a particular of the at least one network management sub-agent processes 211 is responsible for a particular SNMP request (concerning for example the value of a variable characterizing a special property of the network).

Each of the network management sub-agent processes 211 is further coupled to one Management Information Base (MIB) 212. Each Management Information Base 212 is designed for specifying predefined variables of an application to be monitored. A MIB 212 is usually defined in the Abstract Syntax Code ASN.1. In the embodiment shown in FIG. 2C, each of the three sub-agent processes 211 is coupled to a MIB 212.

The further conversion unit 213 is capable of converting a file from the XML format into the ASN.1 format. This feature can be of relevance, if a user who is not familiar with the difficult ASN.1 format prefers to input MIB information in the easier XML format. In such a scenario, the further conversion unit 213 carries out the conversion of the XML input into the ASN.1 format.

The network management master-agent process 201 as well as each of the sub-agent processes 211 can be operated on a UNIX operating system. According to a preferred embodiment of the invention, at least one of the agent processes 201, 211 is operated on a Hewlett Packard UNIX operating system. However, the latter is just an example for a suitable operating system, any other suitable operating system can be used instead without departing from the spirit or the scope of the invention. This would however require porting the code of the current invention to the other operating system.

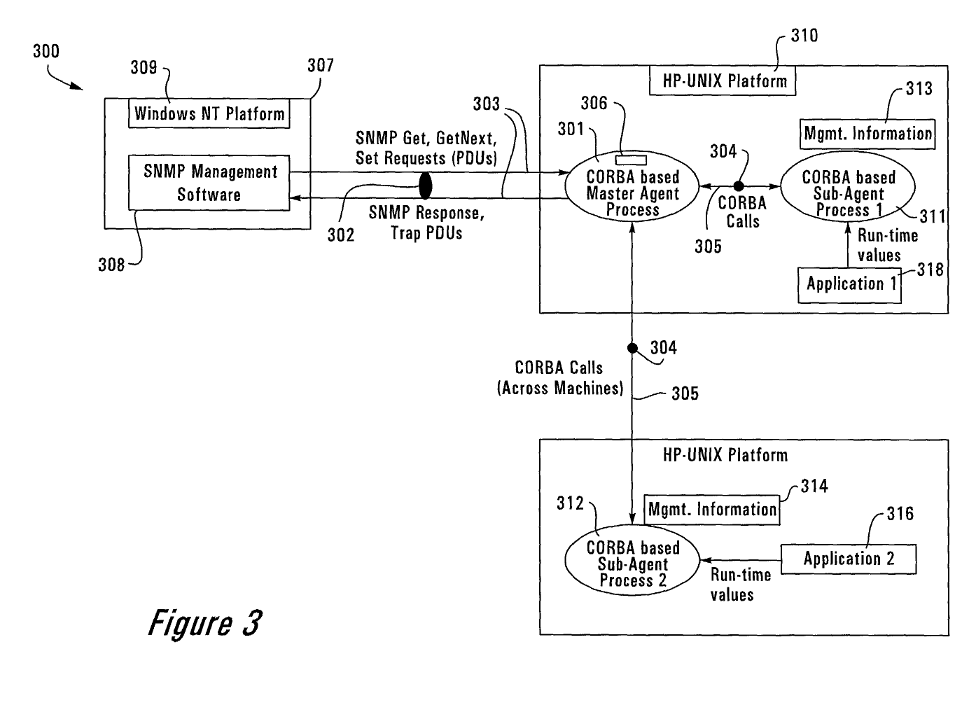

FIG. 3 shows another preferred embodiment of the network management system 300 of the invention. Referring to FIG. 3, the network management system 300 comprises a CORBA-based network management master-agent process 301 having a first interface 302 being adapted to communicate with a network management software module using SNMP as network management protocol format 303, further having second interfaces 304 being adapted to communicate with a plurality of network management sub-agent processes using CORBA as object-oriented interface description language format 305. The network management master-agent process 301 further comprises a converting unit 306 for converting a message according to the SNMP format into the CORBA format and for converting a message according to the CORBA format into the SNMP format, respectively.

The embodiment of the network management system according to the present invention illustrated schematically in FIG. 3 further comprises a network management software module 307 coupled to the network management master-agent process 301 via the first interface 302. The management software module 307 of FIG. 3 contains SNMP Management Software 308. The SNMP Management Software 308 is an application based on a graphical user interface for displaying the result of queries and manipulation operations on the objects managed by agent processes on the same or different machines. E.g., the Network Node Manager (NNM), version 5.0, developed by Hewlett Packard is used as SNMP Management Software 308, wherein the SNMP Management Software is operated on a Windows NT platform 309. A graphical user interface can be provided by the management software module 307 enabling a user to work on the network management system 300. However, any other suitable platform can be used instead of the Windows NT platform 309 to operate the SNMP Management Software 308, and the SNMP Management Software 308 is not restricted to the example given above (NNM 5.0).

The communication between the management software module 307 and the network management master-agent process 301 is in one direction via SNMP requests, e.g. Get-, GetNext- or Set-PDUs (Protocol Data Units) and in the opposite direction via SNMP responses, e.g. Trap-PDUs, respectively. By a Get-Request, an Object identified by an OID (Object Identifier) is queried from the management tree, by a GetNext-PDU the best fitting Object is searched from management tree if the OID is only roughly known, and by a Set-PDU a user changes the values of the MIB variables (again by specifying OIDs) on a sub-agent process 311, 312 via the master-agent process 301. An agent process reports information to the management software module 307 by means of a Trap-PDU.

According to the embodiment of the network management system 300 shown in FIG. 3 the CORBA-based master-agent process 301 is operated on a Hewlett-Packard UNIX platform 310. Alternatively, it can be operated on any other UNIX platform or any other suitable operating system. This would require porting of the code.

Via the converting unit 306, an SNMP request is convertible into the CORBA format, and a CORBA-call is convertible into an SNMP response, respectively.

The converting unit 306 as a functional part of the master-agent process 301 carries out the steps of parsing the incoming SNMP request, retrieving the required information (e.g. MIB variables) from the SNMP request message and routing the packet to the responsible sub-agent process 311, 312 via a CORBA call. The CORBA call comprises the information which is received from the SNMP request message and which is needed by the responsible CORBA-based sub-agent process 311, 312 to provide the necessary monitoring information. This translation is part of the functionality of the master-agent process 301.

In this context, SNMP++ is used. SNMP++ is a C++ based SNMP library developed by Hewlett Packard allowing to construct and deconstruct SNMP packets to retrieve information from the request and the response packets, respectively. Using methods provided by this library, the master-agent process 301 deconstructs the SNMP request packets and invokes the CORBA interface 304 of the sub-agent 311, 312. After receiving a reply from the sub-agent 311, 312, the master-agent process 301 again makes use of the methods and constructs an SNMP packet which is sent back to the network management software module 307.

The network management system 300 further comprises two CORBA-based sub-agent processes 311, 312 coupled to the network management master-agent process 301 via second interfaces 304. As shown schematically in FIG. 3, the first sub-agent process 311 and the master-agent process 301 are operated on the same computer with a Hewlett Packard UNIX operating system. In contrast to this, the second sub-agent process 312 is operated on a computer different from the one on which the master-agent process 301 is operated. However, also the second sub-agent process 312 is operated on a computer with a Hewlett Packard UNIX operating system. This example shows that the network management system of the invention is not restricted to applications running on a single, localized computer, but that distributed applications operated on different machines are supported.

As shown in FIG. 3, the first and the second sub-agent process 311, 312 each are coupled to a Management Information Base 313, 314 The MIB 313 specifies the management information in terms of objects to be managed (predefined variables) of the first application 315 to be monitored. Referring to FIG. 3, the first application 315 can communicate with the first CORBA-based sub-agent process 311. Referring to FIG. 3, the second application 316 can communicate with the second CORBA-based sub-agent process 312. The sub-agent process 311, 312 provides the OID of the MIB variable for which it has received the SNMP request, and the application 315, 316 is responsible for providing the value corresponding to the incoming OID.

The network management system 300 of the present invention is not restricted to the described scenario in which only single MIB variables are specified in a MIB 313, 314. Beyond this, also one or more tables of MIB variables can be specified in a MIB 313, 314. For instance, all the MIB variables at the leaf nodes of the management tree can be identified as belonging to a particular table of MIB variables. According to a preferred embodiment of the network managing system of the invention, multiple instances of MIB variables can be monitored and managed in one go.

In the preferred embodiment of the network management system 300 the first and the second network management sub-agent processes 311, 312 each comprise a further conversion unit (not shown in FIG. 3) for converting MIB data specified by a user in the XML format into the ASN.1 format. This feature of the invention is described above in more detail.

Summarizing, a single instance of master-agent process 301 is adapted to communicate with multiple (two in the embodiment of FIG. 3) instances of sub-agent processes 311, 312 to collect information to be monitored and managed from distributed applications 315, 316. The master-agent process 301 is the central point of monitoring of the network management system 300.

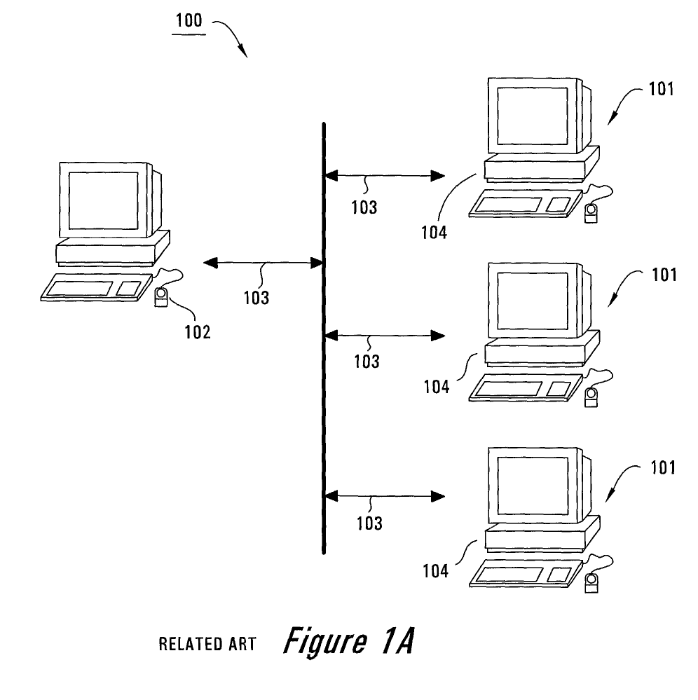

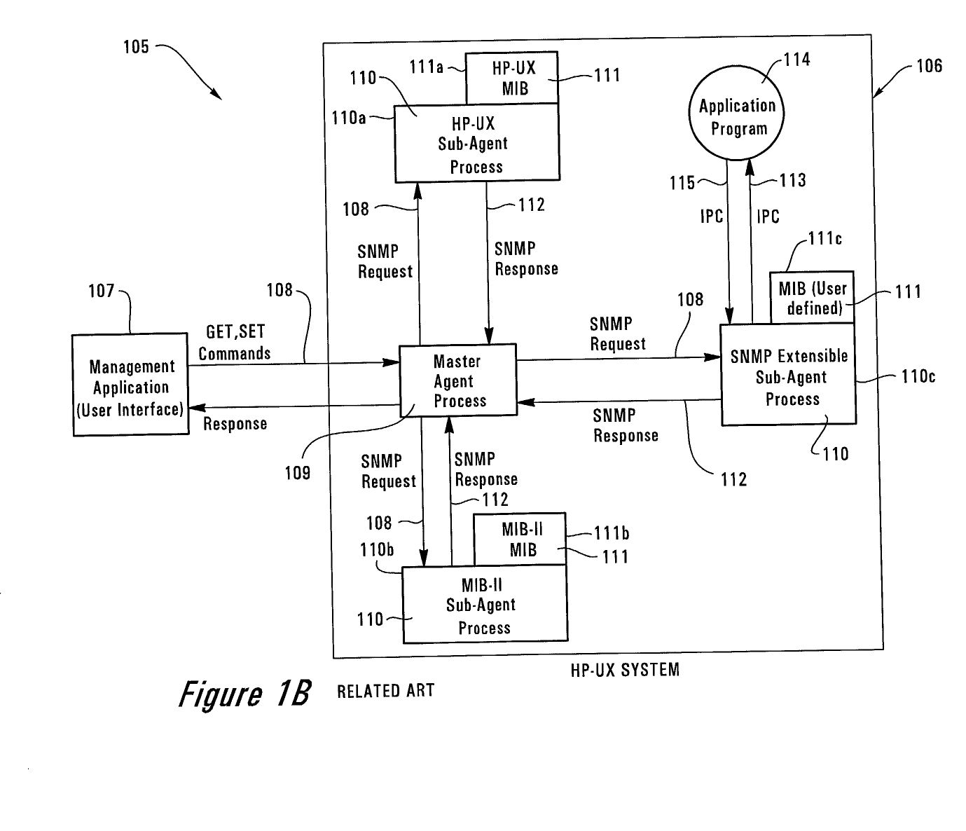

According to a further preferred embodiment of the network management system of the present invention, it is additionally provided support for standard SNMP monitoring through the Hewlett Packard UNIX sub-agent process and the MIB II sub-agent process needs to be provided (compare FIG. 1B). Therewith, the applicability of the network management system of the present invention is broadened.

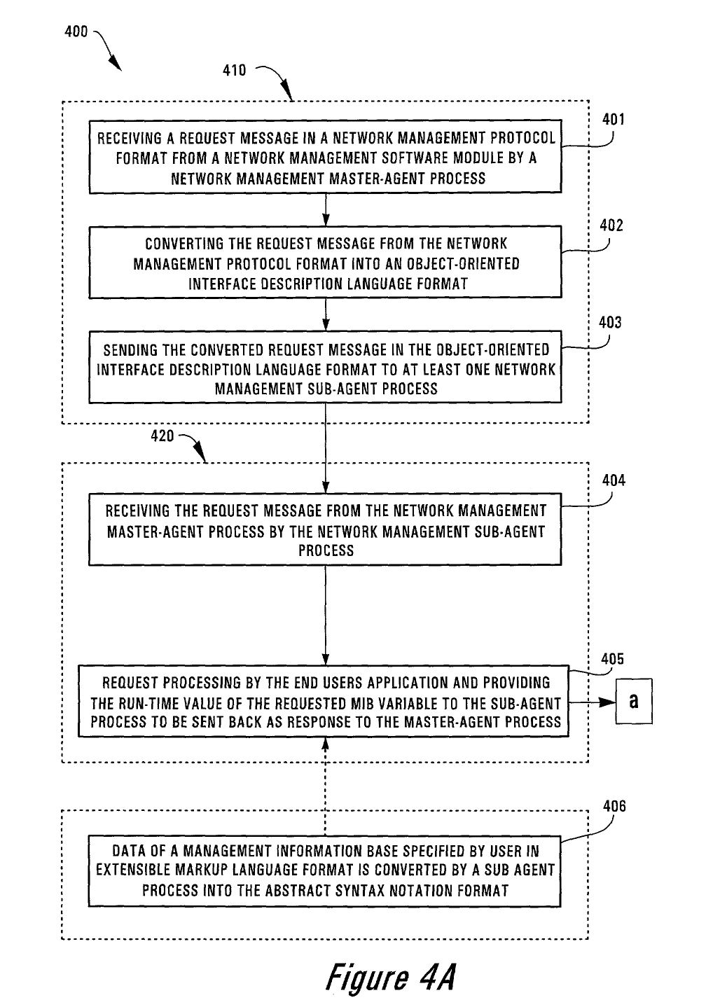

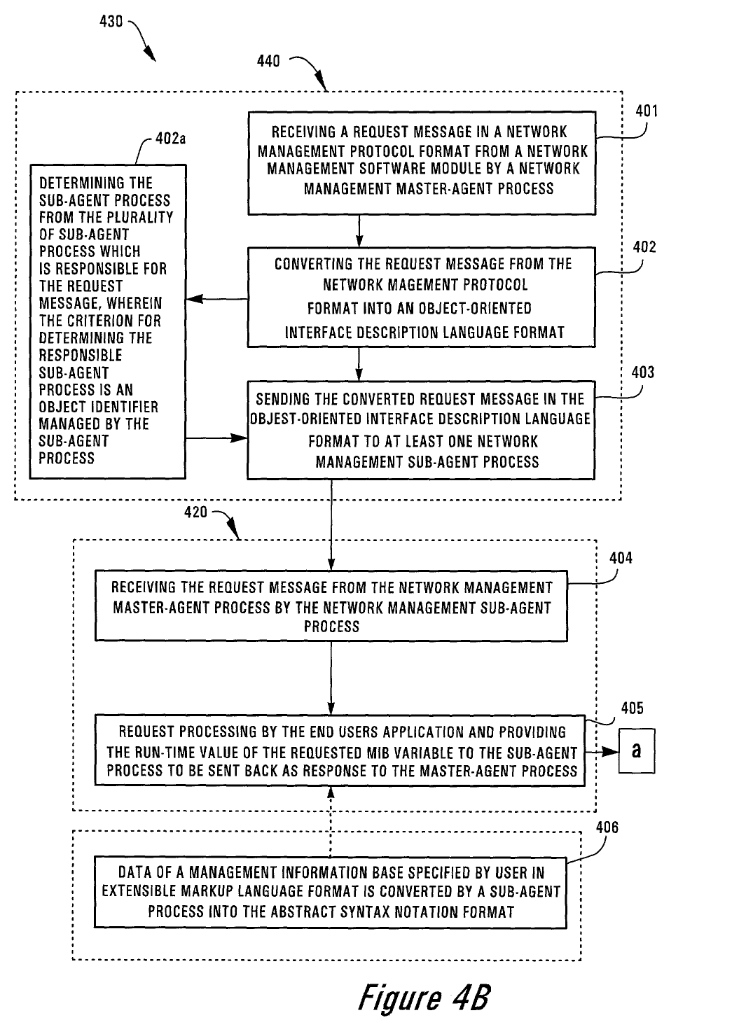

Referring now to FIG. 4A, a flowchart of a preferred embodiment of the computer-based method for network management according to the present invention is described in detail. The method or parts of the method are applied to the network management system of the invention, for instance to any of the embodiments of the system illustrated in FIG. 2A, FIG. 2B, FIG. 2C, FIG. 3. For the sake of clarity, reference signs are mentioned in the following explanation of the computer-based method for network management 400 at the appropriate positions, where the method 400 is referred to elements of the network management system 210 shown in FIG. 2C, for instance.

According to the embodiment illustrated by the flowchart of FIG. 4A, the method 400 comprises the following steps:

Step 401: Receiving a request message in a network management protocol format 203 from a network management software module 208 by a network management master-agent process 201.

Preferably, the network management protocol format 203 is the SNMP format. Alternatively, the network management protocol format 203 can be the SNMPv2. For instance, an SNMP request like a Get-PDU sent from a user operating a GUI-based SNMP management software on a network management software module 208 is received by the master-agent process 201 in step 401.

Step 402: Converting the request message from the network management protocol format 203 into an object-oriented interface description language format 205.

In step 402, the request, e.g. the SNMP request, is converted into an object-oriented interface description language format 205. Preferentially, the object-oriented interface description language format 205 is CORBA. This conversion is necessary, as the master-agent process 201 is communicating in different languages with a network management software module 208 on the one hand and with sub-agent processes 211 on the other hand. The master-agent process 201 acts as a gateway between the SNMP and the CORBA format.

Step 403: Sending the converted request message in the object-oriented interface description language format 205 to at least one network management sub-agent process 211.

The request which has been converted from the network management protocol format 203 into the object-oriented interface description language format 205 (e.g. from SNMP into CORBA) is routed in step 403 to the appropriate sub-agent process 211.

In FIG. 4A, the steps 401, 402, 403 concerning the activity of the master-agent process 201 are composed to a block of steps 410. Analogous, the following steps 404, 405 concerning the activity of the responsible sub-agent process 211 are composed to a block of steps 420.

Step 404: Receiving the request message from the network management master-agent process 201 by the network management sub-agent process 211.

In step 404, the request is received by a particular of the sub-agent processes 211 which is responsible for the request. The received message is the request in the object-oriented interface description language format 205, for instance CORBA.

Step 405: Request processing by the end users application and providing the run-time value of the requested MIB variable to the sub-agent process 211 to be sent back as response to the master-agent process 211.

In other words, the requested MIB variable according to the received request is determined and provided to the sub-agent process 211. The determined MIB variable is then sent back to the master-agent process 201. In Step 405, the user's code which is a part of the sub-agent code processes the request (which contains the OID of the requested MIB variable) and provides the value for the requested MIB variable. The sub-agent process 211 then sends this value to the master-agent process 201 as the response.

Step 406: Data of a Management Information Base 212 specified by a user in Extensible Markup Language format is converted by a sub-agent process 211 into the Abstract Syntax Notation format.

Step 406 is an optional step in the frame of the computer-based method for network management by which an optional service for the user is provided. In the related art, a MIB 212 corresponding to a particular application has to put in by the user in the ASN.1 format. For the sake of an improved operating convenience the method according to the present invention provides the opportunity that a user puts in the MIB information in the simple XML (Extensible Markup Language) format and that in step 406 this ASN.1 code is generated from the XML code. Obviously, step 406 does not necessarily have to be carried out directly after step 405. A reasonable strategy would be that step 406 is carried out at the very beginning of the method 400, i.e. before carrying out step 401.

Referring now to FIG. 4B, the flowchart of a computer-based method for network management 430 which is slightly different from the method 400 illustrated in FIG. 4A is shown. The difference between the methods 400 and 430 corresponding to the flowcharts of FIG. 4A and FIG. 4B, respectively, is that block 410 is replaced by block 430. Block 430 differs from block 410 by comprising the further step 402a to be carried out after step 402 and before step 403:

Step 402a: Determining the sub-agent process 211 from the plurality of sub-agent processes 211 which is responsible for the request message, wherein the criterion for determining the responsible sub-agent process 211 is an Object Identifier managed by the sub-agent process 211.

“Determining” in step 402a means that it is found out which sub-agent process 211 of the plurality of sub-agent processes 211 is responsible for the MIB variable(s) in the request packet, i.e. which sub-agent process 211 implements the MIB 212 to which the requested MIB variable(s) belong(s). The master-agent process 201 performs the check whether the request can be serviced by any of the registered sub-agent processes 211. In other words, the master-agent process 201 performs a lookup in its internal registry to see which sub-agent processes 211 have registered with it and which sub-agent process(es) is/are responsible for the requested MIB variable(s). This is done by checking the Object Identifier (OID). All the MIB variables have a unique OID specified in the MIB 212. The sub-agent processes 211 register the starting OID of the MIB 212. If a requested OID falls under the management tree of a MIB 212 registered by a sub-agent process 211, then the master-agent process 201 has the relevant information to determine which of the sub-agent processes 211 is responsible for the present request. This means that the master-agent process 201 assumes that any MIB variable under a starting one will also be supported by the sub-agent process 211.

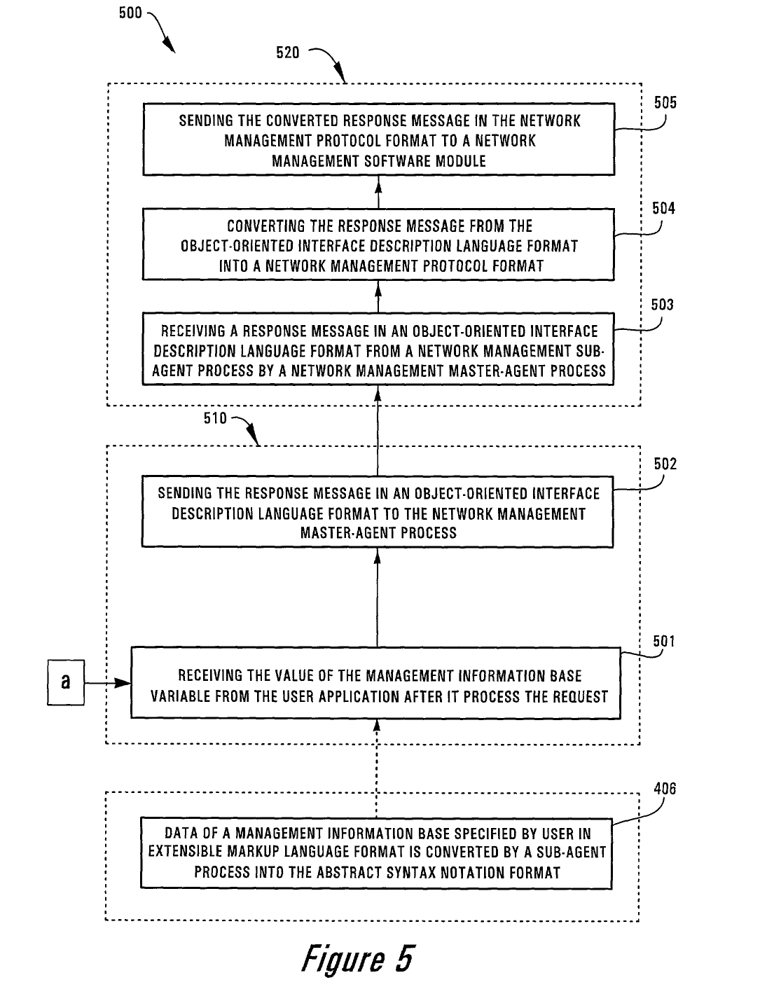

In FIG. 4A and in FIG. 4B a box labelled “a” is illustrated subsequent to step 405. This box shall indicate that after having carried out step 405, the computer-based method for network management 400 or 430, respectively, reasonably can continue to carry out step 501 illustrated in the flowchart of FIG. 5.

However, the computer-based method for network management 500 (or individual steps or parts from that method) can be carried out as a separate method and independent from methods 400 or 410 described above. A flowchart of this method 500 is illustrated in FIG. 5.

Nevertheless, it can be reasonable to put together the flowcharts of FIG. 4A, FIG. 4B on the one hand and of FIG. 5 on the other hand after having performed step 406. This is indicated by the box labelled “a” in FIG. 4A, FIG. 4B, FIG. 5.

The computer-based method for network management 500 comprises the following steps:

Step 501: Receiving the value of the Management Information Base variable from the user application after it processes the request.

The responsible sub-agent process 211 is provided the run-time value of the requested MIB variable by the users application. This is based on the OID of the MIB variable in the incoming request packet.

Step 502: Sending the response message in the object-oriented interface description language format 205 to the network management master-agent process 201.

According to a preferred embodiment of the method 500, the sub-agent process 211 sends back the response to the master-agent process 201 via a CORBA-call. In case an error is encountered, the appropriate error code is sent back to the master-agent process 201.

In FIG. 5, the steps 501, 502 concerning the activity of the responsible sub-agent process 211 are composed to a block of steps 510. Analogous, the subsequent steps 503, 504, 505 concerning the activity of the master-agent process 201 are composed to a block of steps 520.

Step 503: Receiving a response message in an object-oriented interface description language format 205 from a network management sub-agent process 211 by a network management master-agent process 201.

The master-agent process 201 receives the requested information in the form of a response in an object-oriented interface description language format 205 from the responsible sub-agent process 211. Preferably, this step is realized by a CORBA-call.

Step 504: Converting the response message from the object-oriented interface description language format 205 into a network management protocol format 203.

The master-agent process 201 prepares an appropriate package in the network management protocol format 203 by converting the response message from the object-oriented interface description language format 205. For instance, an SNMP package is constructed from the information which the CORBA call contains.

Step 505: Sending the converted response message in the network management protocol format 203 to a network management software module 208.

The response is sent back to the network management software module 208 in the network management protocol format 203, e.g. the SNMP format. The management software is therewith provided with the information required for monitoring and managing the network system. Preferably, the network management software module 208 is equipped with an graphical user interface 209 enabling a user to supervise the network monitoring and management.

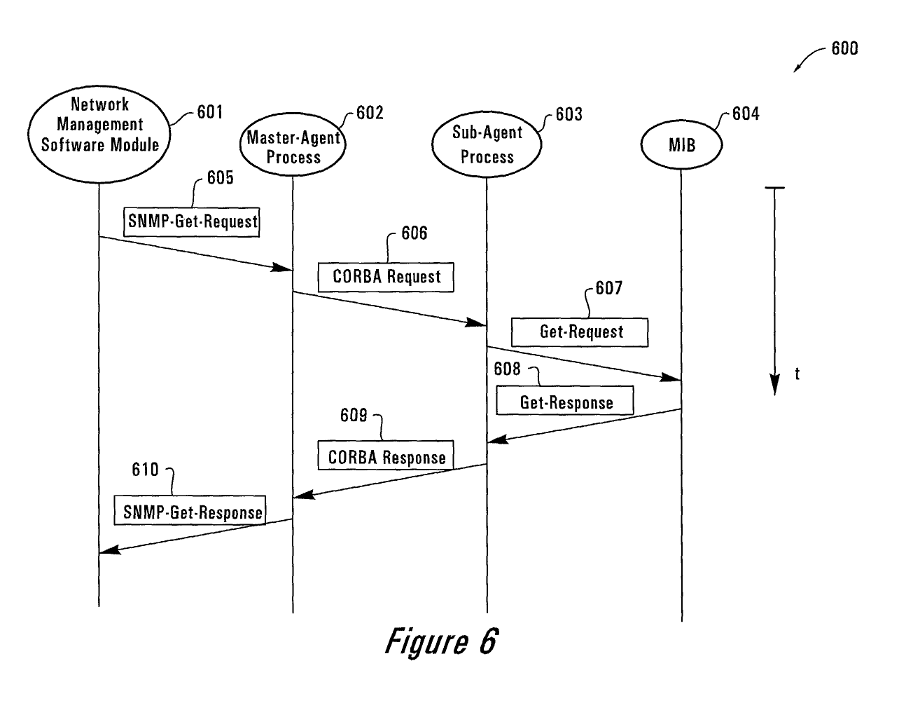

FIG. 6 shows a data flowchart 600 of the computer-based methods 400, 430, 500 for network management described above referring to FIG. 4A, FIG. 4B and FIG. 5 according to a preferred embodiment of the present invention. This data flowchart 600 visualizes the processes forming the computer-based methods for network management 400, 430, 500 of the present invention assuming that these methods are applied to the network management system 210 or 300, respectively, of the invention.

Referring to FIG. 6, an SNMP Get-Request 605 is sent from the network management software module 601 to the master agent process 602. This request is converted into the CORBA format and then forwarded to the responsible sub-agent process 603 by a CORBA-request 606. The sub-agent process 603 receives the CORBA-request 606, and after appropriate processing by the users application (607, 608) forwards a CORBA-Response 609 to the master-agent process 602. The master-agent process 602 converts the information into the SNMP format and passes the constructed SNMP-package back to the network management software module 601 by sending an SNMP-Get-Response 610.

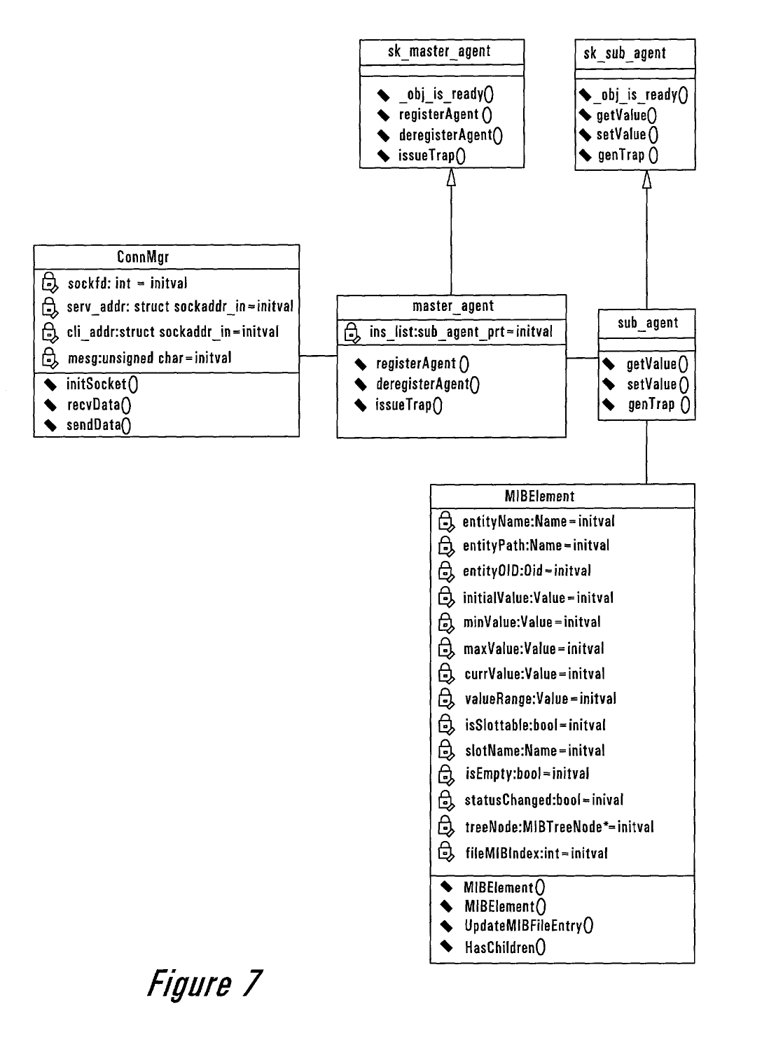

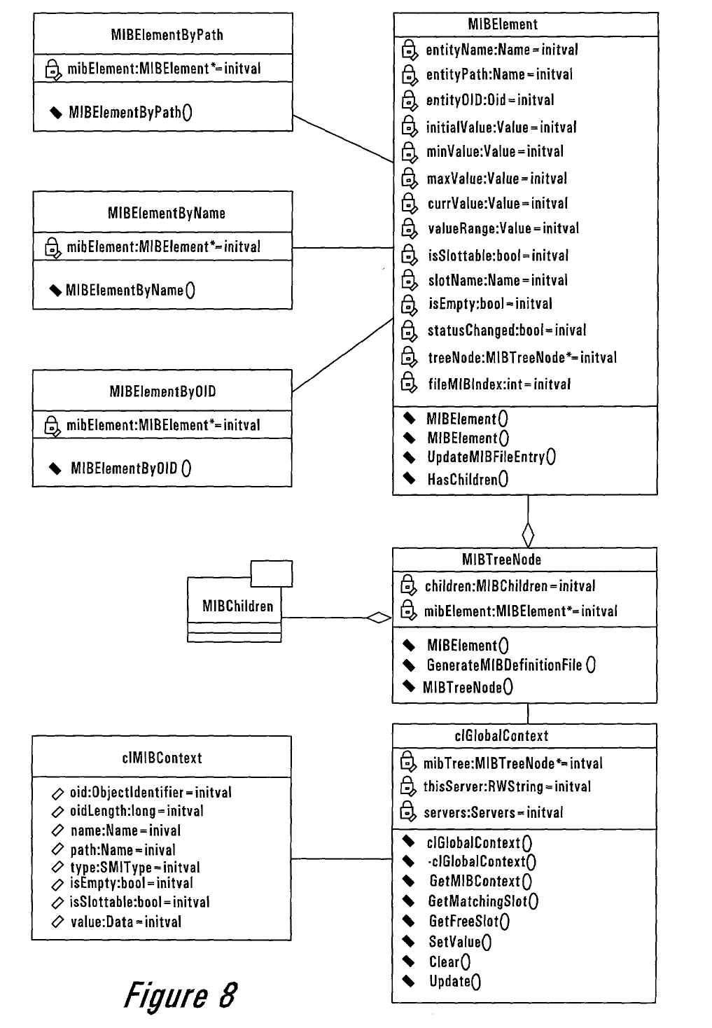

In the following, the design of the master-agent—sub-agent architecture according to the preferred embodiment of the invention will be described. FIG. 7 and FIG. 8 are diagrams showing the relationships of the classes for the master-agent—sub-agent architecture and for the sub-agent process architecture, respectively, according to a preferred embodiment of the present invention. The network management system has been designed as a collection of interacting classes. The details of each of the classes are given below:

Class Name: ConnMgr

This class is responsible for managing the socket connections for the master-agent process. It initialises the socket and binds to the appropriate port for the master-agent process to begin processing requests.

Private Attributes:

int sockfd=initval

The socket file descriptor for the socket to which the master-agent process binds

struct sockaddr_in serv_addr=initval

The Standard socket structure for the server address socket details

struct sockaddr_in cli_addr=initval

The Standard socket structure for maintaining the client address socket details

unsigned char mesg=initval

The buffer to hold the raw SNMP packet which gets sent by the Network Management Application. Max size 4096.

Public Operations:

void initSocket (void)

This method performs all the initializations for the master-agent processes socket connection. It binds to port 161 (Standard UPD port) and allows the master-agent process to begin processing requests.

unsigned char* recvData (int & mesg_len)

This method performs a receive of the SNMP packets from the socket connection established by the initSocket function and passes it to the master-agent process for further processing.

bool sendData (void * data, int msglen)

This method is responsible for sending the response SNMP packet to the Network management Application from where the SNMP request had originated. It returns back a bool, indicating whether the send was successful or not.

ClassName: sk_master_agent

This is the base class generated by the omniORB IDL compiler from the IDL interfaces specified for the master-agent process. It is mandatory for the implementation to derive from this base class.

Public Operations:

void_obj_is_ready (CORBA::BOA_ptr boa)

This is a IDL generated function and is invoked by the application to announce that it is ready to service requests.

int registerAgent ( )

virtual method which the master_agent_i class has to implement

void deregisterAgent ( )

virtual method which the master_agent_i class has to implement

void issueTrap ( )

virtual method which the master_agent_i class has to implement

Class Name: master_agent

This class encapsulates the functionality of the master-agent processes interface to the sub-agent processes. It provides the sub-agent processes a mechanism to register or deregister with the master-agent process.

Derived from sk_master_agent

Private Attributes:

sub _agent_ptr inst_list=initval

A vector which is used by the master-agent process to store the references of all the sub-agent processes which have registered with it. Of the type “sub-agent_ptr” which is CORBA data type for the sub-agent process

Public Operations:

int registerAgent (sub_agent_i agent_inst, const char* start_oid)

This function is invoked by the sub-agent processes to register themselves with the master-agent process. The sub-agent process needs to provide a reference to itself and starting OID for the MIB tree that it will be responsible for. The master-agent process stores this information in its internal registry. This method returns an id to the sub-agent process, which identifies it uniquely in the CSNMP system. This id needs to be specified at the time of sub-agent process deregisteration.

void deregisterAgent (int instance_id)

This function is responsible for deregistering the sub-agent process. The master-agent process removes the sub-agent process reference from its internal registry once this function is invoked. The sub-agent process instance id generated by the registerAgent method is passed as an argument to this function for identification purposes. After the master-agent process has removed the sub-agent process reference, no SNMP requests will be forwarded to the sub-agent process.

bool issueTrap (const char* trapname, int trapid, void * trapdata)

This function allows applications to issue SNMP traps which will be visible at the Network Management Station.

Class Name: sk_sub_agent

This is the base class generated by the omniORB IDL Compiler from the IDL interface specified for the sub-agent process. It is mandatory for the implementation to derive from this base class.

Public Operations:

void_obj_is_ready (CORBA::BOA_ptr boa)

This is a IDL generated function and is invoked by the application to announce that it is ready to service requests.

void getValue ( )

virtual method which the sub_agent_i class has to implement

void setValue ( )

virtual method which the sub_agent_i class has to implement

void genTrap ( )

virtual method which the sub_agent_i class has to implement

Class Name: sub_agent

This class encapsulates the functionality of the sub-agent process. It provides the master-agent process an interface to Retrieve and Modify the MIB variables supported by the sub-agent process.

Derived from sk_sub_agent

Public Operations:

void getValue (MibValue mibval, int mibvar_count)

This method is used by the master-agent process to retrieve MIB values from the sub-agent process. It accepts the MIB variables as arguments (for which the SNMP GET request was issued by the Management Application) and passes it on to the application logic for retrieving the actual value. The values filled in by the application are sent back packaged in a CORBA sequence. The CORBA sequence is defined as a two-way sequence, so the sub-agent process does not explicitly need to return back the sequence. It will be transparently made available to the master-agent process by the underlying ORB (Object Request Broker)

void setValue (char * oid, char * value)

This function is invoked by the master-agent process in case the Management Application wishes to modify the values of any of the MIB variables supported by the sub-agent process. It passes on the request to the application logic, which is responsible for carrying out the request.

void genTrap (argname)

used by the application logic to issue traps to the master-agent process which will then forward the trap to the Network management Application.

Class Name: MIBElement

Used to store the MIB elements specified in the user-defined MIB. It has all the information pertaining to a MIB variable.

Private Attributes:

Name entityName=initval

Name of the MIB element.

Name entityPath==initval

Fully qualified path of the MIB element in the directory structure.

Oid entityOlD=initval

The OID of the MIB Element.

Value initialValue=initval

Value minValue==initval

Value maxValue=initval

Value currValue=initval

Range valueRange=initval

Range indicating whether: the currValue is below min, within range or above maximum.

bool isSlottable==initval

Indicates if there are multiple instances of any MIBElement under this MIBElement.

Name slotName=initval

Indicates the base name of the MIBElement that has multiple instances.

bool is Empty=initval

Indicates if the entry for this MIBElement is empty in the memory mapped file.

bool statusChanged=initval

Indicates the change of Status between empty and non-empty

MIBTreeNode * treeNode=initval

treeNode corresponding to this MIBElement.

int fileMIBIndex=initval

Index in the memory mapped file for this MIBElement entry.

Public Operations:

void MIBEIement ( )

Default constructor

void MIBEIement (Name mibDirectoryElementPath, Oid elementOID, MIBTreeNode * mibTree=NULL, MIBEIement * copyElement=NULL)

ResultFlag UpdateMIBFileEntry ( )

To Update the value of the MIBElement.

bool HasChildren ( )

To test if there are any MIBEIements under this MIBEIement (according to the structure specified in the XML file).

Class Name: MIBTreeNode

This class is responsible for maintaining the hierarchical structure of the MIB as specified by the user in the XML file. It maintains information regarding the parent node of a particular MIB variable and also the corresponding children of each MIB variable. This helps in generating the ASN.I file from user supplied information and also in locating the MIB variables when needed to service a Get or a Set request.

Private Attributes:

MIBChildren children=initval

A vector MIBTreeNodes that are under this MIBTreeNode.

MIBElement * mibElement=initval

MIBElement corresponding to this MIBTreeNode

Public Operations:

void MIBTreeNode (Name mibPath, Oid startOID, RWHashTable mibTableByPath, RWHashTable mibTableByName, RWHashTable mibTableByOlD, MIBTreeNode * copyNode=NULL)

Constructor. This also acts as the copy constructor

ResultFlag GenerateMIBDefinitionFile (char * fileName)

void ˜MIBTreeNode ( )

Destructor

Class Name: MIBChildren

A ordered vector of MIBTreeNodes. Used by the MIBTreeNode class to store the children nodes under each MIB node.

Class Name: MIBElementByPath

MIBElement that will be hashed by Path. The Path is the relative path of each MIB variable under the top-level MIB node. This class helps in retrieving a specified MIB variable based on its relative path in the MIB hierarchy.

Private Attributes:

MIBEIement * mibElement=initval

Points to corresponding MIBElement

Public Operations:

void MIBEIementByPath ( )

Constructor

Class Name: MIBElementByName

MIBElement that will be hashed by Name. Performs operations similar to the MIBElementByPath class, except that it locates the element based on its name, provided that the name is unique. ASN.1 does not allow two MIB variables to have the same name.

Private Attributes:

MIBElement * mibElement=initval

Points to corresponding MIBElement

Public Operations:

void MIBElementByName (argname)

Constructor

Class Name: MIBElementByOlD

MIBElement that will be hashed by OID. Helps in locating elements based on their unique Object Identifiers.

Private Attributes:

MIBElement * mibElement=initval

Points to corresponding MIBElement

Public Operations:

void MIBEIementByOlD ( )

Constructor

Class Name: clGlobalContext

Stores the MIB Context of the MIBTreeNode

Private Attributes:

MIBTreeNode * mibTree=initval

MIBTreeNode corresponding to this clGlobalContext

RWString thisServer=initval

Server where nodemon is running.

Servers servers=initval

List of Servers configured in the monitoring setup.

Public Operations:

void clGlobalContext ( )

void ˜clGlobalContext (argname)

Destructor

clMIBContext * GetMIBContext (char * contextName)

Returns clMIBContext after filling it with data pertaining to the MIB element pointed to by contextName

clMIBContext * GetMatchingSlot (clMIBContext & mib, char * attributeValue)

Returns clMIBContext if the value of mib is equal to attributeValue

clMIBContext * GetFreeSlot (clMIBContext & mib)

Returns the first slot available for mib

void SetValue (long mibElementPtr, Data smiValue)

API to set the value of the MIB element

A sample MIB file represented in XML is presented below. A file such as this needs to be provided by the end user to the sub-agent process. The tags can be user-defined, but the rest of the information regarding the tags needs to be in the format specified. The example MIB presented here captures management information for a software component called “Component1”. The attributes for “Component1” that have been captured are

Name

Status

ComponentAvailable

StartTime

StopTime

The user also needs to provide the SNMP data type that each of these variables correspond to. This information is provided in the type field for each tag. For example the Name attribute is of type OctetStr. The information whether a variable can only be queried or also manipulated is provided in the access field for each tag. For example the Name attribute has the access type “readonly”, which specifies that the variable's value can be only queried. In other words only the SNMP-GET operations are supported for this variable and not SNMP-SET operations. The information provide in the description field is optional. It can be left blank if the user does not desire to provide any textual description for an attribute.

The type and access fields need to be provided only for the leaf nodes in the MIB, that is variables which hold actual values and which can be queried and manipulated. For example the variable Component1 is just a logical one to group the information regarding Component1. It does not have a value of its own. However all the attributes defined under the Component1 tag have definite values which can be queried or manipulated or both depending on the access that is provided for them.

The XML-code of the sample MIB file is presented in the following:

<MIB >

<Component1 description=“Component to be monitored” >

<Name type=“OctetStr” access=“readonly”

description=“The Name of the software process”/>

<Status type=“Uint32” access=“readwrite”

description=“Up or Down”/>

<ComponentAvailable type=“Uint32”

access=“readwrite” description=“Ready to process requests”/>

<StartTime type=“TimeTicks” access=“readonly”

description=“When the component was last started”/>

<StopTime type=“TimeTicks” access=“readonly”

description=“When the component was last stopped”/>

</Component1 />

</MIB>

The sub-agent process parses the XML file. It makes use of the expat parser for doing so. It initializes the internal data structures and also generates an ASN.1 file from the XML input file. The corresponding ASN.1 file for the sample XML file is presented below.

Component1-MIB DEFINITIONS ::= BEGIN
Component1 OBJECT IDENTIFIER ::= { enterprises
MYORG(1299) 6}

| | |
|---|---|
| Name | OBJECT-TYPE |

SYNTAX OCTET STRING
ACCESS read-only
STATUS mandatory
DESCRIPTION “
name of the software process”
::= { Component1 1 }

| | |
|---|---|
| Status | OBJECT-TYPE |

SYNTAX INTEGER
ACCESS read-write
STATUS mandatory
DESCRIPTION “
Up or Down”
::= { Component1 2 }

| | |
|---|---|
| ComponentAvailable | OBJECT-TYPE |

SYNTAX INTEGER
ACCESS read-write
STATUS mandatory
DESCRIPTION “
Ready to processrequests or not”
::= { Component1 3 }

| | |
|---|---|
| StartTime | OBJECT-TYPE |

SYNTAX TimeTicks
ACCESS read-only
STATUS mandatory
DESCRIPTION “
Time when the component was last started”
::= { Component1 4 }

| | |
|---|---|
| StopTime | OBJECT-TYPE |

SYNTAX TimeTicks
ACCESS read-only
STATUS mandatory
DESCRIPTION “
Time when the component was last stopped”
::= { Component1 5 }

END

The ASN.1 file needs to be moved to the machine where the Network Management Software Module is running (say a Windows NT machine). It needs to be loaded by the management software and then it would represent this file in a hierarchical order. The end user can then select a particular MIB variable and issue GET or SET requests on that MIB variable.

What is claimed is:

1. Network management system
comprising a network management master-agent process having
a first interface being adapted to communicate with a network management software module using a network management protocol format;
a second interface being adapted to communicate with a plurality of network management sub-agent processes using an object-oriented interface description language format;
the network management master-agent process further comprising a converting unit for converting
a message according to the network management protocol format into the object-oriented interface description language format;
a message according to the object-oriented interface description language format into the network management protocol format.

2. Network management system according to claim 1, further comprising a network management software module coupled to the network management master-agent process via the first interface.

3. Network management system according to claim 2, wherein the network management software module comprises a graphical user interface for presenting network management information to a user.

4. Network management system according to claim 1, wherein the network management protocol is the Simple Network Management Protocol or the Simple Network Management Protocol Version 2.

5. Network management system according to claim 1, wherein the object-oriented interface description language is the Common Object Request Broker Architecture.

6. Network management system according to claim 1, further comprising a plurality of network management sub-agent processes coupled to the network management master-agent process via the second interface.

7. Network management system according to claim 6, further comprising one Management Information Base for each network management sub-agent process
wherein each Management Information Base is coupled to the network management sub-agent process;
wherein each Management Information Base is designed for specifying the structure of management information in terms of the objects to be managed (predefined variables) of an application to be monitored.

8. Network management system according to claim 7, wherein at least one of the Management Information Bases is defined in the Abstract Syntax Notation code.

9. Network management system according to claim 8, wherein at least one of the network management sub-agent processes comprises a further conversion unit for converting data of a Management Information Base specified by a user in Extensible Markup Language format into the Abstract Syntax Notation format.

10. Network management system according to claim 9, wherein at least one of the network management agent processes is operated on a Hewlett-Packard UNIX operating system.

11. Computer-based method for network management, comprising the following steps:
Receiving a request message in a network management protocol format from a network management software module by a network management master-agent process;
Converting the request message from the network management protocol format into an object-oriented interface description language format;
Sending the converted request message in the object-oriented interface description language format to at least one network management sub-agent process.

12. Computer-based method for network management according to claim 11, wherein the network management protocol is the Simple Network Management Protocol or the Simple Network Management Protocol Version 2.

13. Computer-based method for network management according to claim 11, wherein the object-oriented interface description language is the Common Object Request Broker Architecture.

14. Computer-based method for network management according to claim 11, comprising the further step of determining the sub-agent process from the plurality of sub-agent processes which is responsible for the request message, wherein the criterion for determining the responsible sub-agent process is an Object Identifier managed by the sub-agent process.

15. Computer-based method for network management according to claim 14, comprising the further step that data of a Management Information Base specified by a user in Extensible Markup Language format is converted by a sub-agent process into the Abstract Syntax Notation format.

16. Computer-based method for network management according to claim 11, wherein at least one of the network management agent processes is operated on a Hewlett-Packard UNIX operating system.

17. Computer-based method for network management, comprising the following steps:
Receiving a response message in an object-oriented interface description language format from a network management sub-agent process by a network management master-agent process;
Converting the response message from the object-oriented interface description language format into a network management protocol format;
Sending the converted response message in the network management protocol format to a network management software module.

18. Computer-based method for network management according to claim 17, further comprising the following steps to be carried out before carrying out the steps of claim 17:
Receiving the value of the Management Information Base variable from the user application after it processes the request;
Sending the response message in the object-oriented interface description language format to the network management master-agent process.

19. Computer-based method for network management according to claim 18, wherein the network management protocol is the Simple Network Management Protocol or the Simple Network Management Protocol Version 2.

20. Computer-based method for network management according to claim 17, wherein the object-oriented interface description language is the Common Object Request Broker Architecture.

21. Computer-based method for network management according to claim 18, wherein the Management Information Base is designed for specifying the structure of management information in terms of the objects to be managed (predefined variables) of an application to be monitored.

22. Computer-based method for network management according to claim 18, wherein the Management Information Base is defined in the Abstract Syntax Notation code.

23. Computer-based method for network management according to claim 22, comprising the further step that data of a Management Information Base specified by a user in Extensible Markup Language format is converted by a sub-agent process into the Abstract Syntax Notation format, wherein the further step is carried out before carrying out the steps of claims 18 and 17.

24. Computer-based method for network management according to claim 17, wherein at least one of the network management agent processes is operated on a Hewlett-Packard UNIX operating system.
